(19) United States
(12) Patent Application Publication
(10) Pub. No.: US 2026/0236015 A1
(43) Pub. Date: Aug. 13, 2026

(54) MANUFACTURING INFORMATION MANAGEMENT DEVICE AND MANUFACTURING INFORMATION MANAGEMENT METHOD

(71) Applicant: FANUC CORPORATION, Minamitsuru-gun, Yamanashi (JP)

(72) Inventor: Nobuhiro HARA, Minamitsuru-gun, Yamanashi (JP)

(21) Appl. No.: 19/475,259

(22) PCT Filed: Jun. 27, 2023
(86) PCT No.: PCT/JP2023/023876

§ 371 Date: Oct. 14, 2025

(51) Int. Cl. G05B 23/02

(52) U.S. Cl. CPC G05B 23/0208

(57) ABSTRACT

The purpose of the present invention is to create, from manufacturing data which is time-series data acquired from equipment, manufacturing performance records for each manufacturing management unit on the basis of preset conditions. This manufacturing information management device is provided with: a manufacturing data acquisition unit that acquires manufacturing data including at least manufacturing-related time-series data from equipment; and a manufacturing performance record creation unit that creates, from the manufacturing data, manufacturing data for each arbitrary manufacturing management unit as manufacturing performance records on the basis of preset manufacturing performance record creation conditions.

### TECHNICAL FIELD

The present disclosure relates to a manufacturing information management device and a manufacturing information management method that generate manufacturing results on a per unit of manufacturing management basis from manufacturing data acquired from facilities.

### BACKGROUND ART

There is a known system that operates industrial machines such as a machine tool and a robot based on manufacturing instructions from a production management system and collects results achieved in accordance with the instructions. For example, see Patent Document 1.

### CITATION LIST

### Patent Document

Patent Document 1: Japanese Unexamined Patent Application, Publication No. 2007-172522

### DISCLOSURE OF THE INVENTION

### Problems to be Solved by the Invention

However, in a case where the production management system and the industrial machines do not have a function of operating based on manufacturing instructions or are not configured to do so, manufacturing result data corresponding to manufacturing instructions cannot be automatically collected unless improvements are made to both the production management system and the industrial machines. In this case, for example, an operator has to record the results on a manufacturing instruction sheet of paper or the like. Furthermore, even in the case where an operator records the results, there may be disadvantages that the recorded contents are not necessarily accurate, the recording is time-consuming, and so on. Further, where numerical control devices are concerned, when a numerical control device cannot receive workpiece information (i.e., the numerical control device does not have such a function or is not linked with a production management system, etc.), it is difficult to associate manufacturing instructions with machining-related data that. can be acquired from the numerical control device.

Therefore, it is desired to generate manufacturing results on a per unit of manufacturing management basis based on preset conditions, from manufacturing data that is time-series data acquired from facilities.

### Means for Solving the Problems

One aspect of a manufacturing information management device of the present disclosure includes: a manufacturing data acquisition unit that acquires manufacturing data including at least manufacture-related time-series data from a facility; and a manufacturing result generation unit that generates, from the manufacturing data, manufacturing data on a per arbitrary unit of manufacturing management as manufacturing results, based on preset manufacturing result generation conditions.

One aspect of a manufacturing information management method of the present disclosure is for causing a computer to function as a manufacturing information management device, and includes: a manufacturing data acquisition step of acquiring manufacturing data including at least manufacture-related time-series data from a facility; and a manufacturing result generation step of generating, from the manufacturing data, manufacturing data on a per arbitrary unit of manufacturing management unit as manufacturing results, based on preset manufacturing result generation conditions.

### BRIEF DESCRIPTION OF THE DRAWINGS

FIG. 1 is a diagram illustrating an example of a configuration of a manufacturing result management system according to one embodiment.

FIG. 2 is a diagram illustrating an example of manufacturing data.

FIG. 3 is a table illustrating an example of manufacturing result generation conditions.

FIG. 4 is a diagram illustrating an example of a relationship between facilities and process steps on a per workpiece type basis.

FIG. 5 is a diagram illustrating an example of a result generation condition list screen.

FIG. 6 is a diagram illustrating an example of a new creation screen.

FIG. 7 is a table illustrating an example of manufacturing results.

FIG. 8 is a table illustrating an example of manufacturing results.

FIG. 9 is a table illustrating an example of manufacturing results.

FIG. 10 is a diagram illustrating an example of a manufacturing result list screen.

FIG. 11 is a flowchart illustrating generation processing by the manufacturing information management device.

### PREFERRED MODE FOR CARRYING OUT THE INVENTION

### One Embodiment

A manufacturing result management system according to one embodiment will be described below in detail with reference to the drawings. The following describes, as an example, a manufacturing result management system in a metalworking factory employing job-shop production and equipped with a plurality of facilities, which are industrial machines such as machine tools and robots, arranged therein. It should be noted that the application of the present invention is not limited to metalworking factories, and the present invention is applicable to any factory having a plurality facilities. Furthermore, the present invention is applicable to various machines as industrial machines such as machine tools, industrial robots, service robots, forging machines, laser processing machines, injection molding machines, and the like.

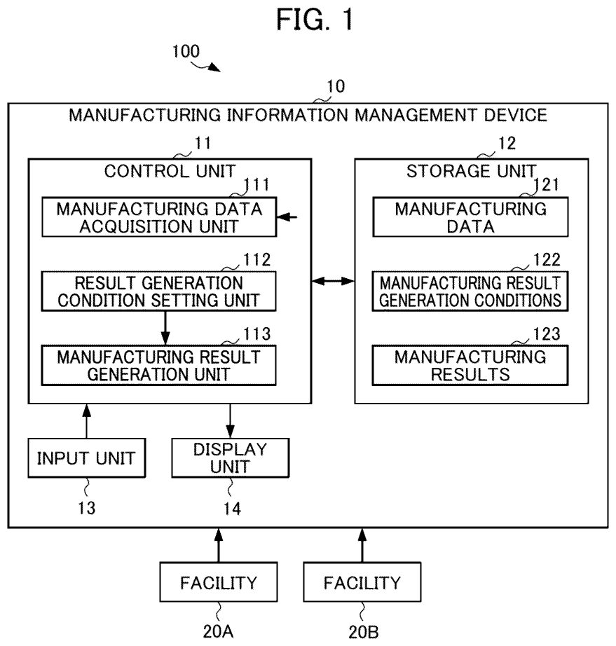

FIG. 1 is a diagram illustrating an example of a configuration of a manufacturing result management system according to one embodiment. As illustrated in FIG. 1, the manufacturing result management system 100 includes, for example, a manufacturing information management device 10 and two facilities 20A and 20B. The manufacturing result management system 100 may include two or more facilities. The manufacturing information management device 10 and the facilities 20A and 20B are connected to each other via a network (not shown) such as a local area network (LAN) or the Internet to communicate with each other. In this case, the manufacturing information management device 10 and the facilities 20A and 20B include a communication unit (not shown) for communicating with each other through such connection. The manufacturing information management device 10 and the facilities 20A and 20B may be directly connected to each other via a connection interface (not shown).

The facilities 20A and 20B are, for example, known industrial machines such as machine tools or robots. The facilities 20A and 20B operate in response to control instructions outputted from a numerical control device or robot control device (not shown) that executes a machining program based on manufacturing instructions from a production management system (not shown). The facilities 20A and 20B output manufacturing data including at least time-series data related to manufacture that is based on the control instructions, to the manufacturing information management device 10 (to be described later). In the following description, the facility 20A is also referred to as “facility A” and the facility 20B is also referred to as “facility B”.

The manufacturing information management device 10 is a known computer device or the like, and acquires the manufacturing data from each of the facilities 20A and 20B that operate based on manufacturing commands from the production management system (not shown). From the acquired manufacturing data, the manufacturing information management device 10 generates manufacturing results on a per unit of manufacturing management basis, based on preset manufacturing result generation conditions, and manages the generated manufacturing results. The unit of manufacturing management indicates a process step for each workpiece type. As illustrated in FIG. 1, the manufacturing information management device 10 includes a control unit 11, a storage unit 12, an input unit 13, and a display unit 14. The control unit 11 includes a manufacturing data acquisition unit 111, a result generation condition setting unit. 112, and a manufacturing result generation unit 113.

### Storage Unit 12

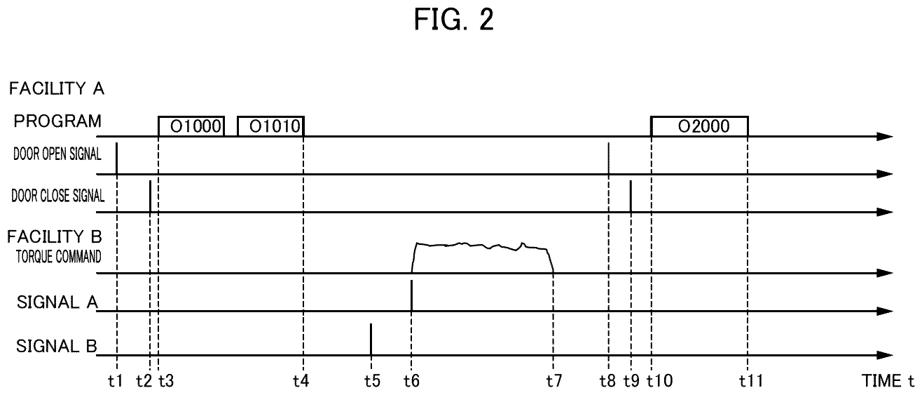

The storage unit 12 is a read only memory (ROM), a random access memory (RAM), a solid state drive (SSD), a hard disk drive (HDD), or the like. The storage unit 12 may store a program for manufacturing result management and the like. The storage unit 12 includes manufacturing data 121, manufacturing result generation conditions 122, and manufacturing results 123. The manufacturing data 121 includes at least manufacture-related time-series data acquired from each of the facilities 20A and 20B by the manufacturing data acquisition unit 111 (to be described later). FIG. 2 is a diagram illustrating an example of the manufacturing data 121. In FIG. 2, the upper portion represents manufacturing data acquired from the facility 20A (facility A), and the lower portion represents manufacturing data acquired from the facility 20B (facility B). As illustrated in FIG. 2, the manufacturing data 121 includes time-series data related to a machining program executed to cause the facility 20A to perform manufacturing operation, and time-series data related to a door open signal and a door close signal for a door of the facility 20A. Further, the manufacturing data 121 includes time-series data related to a torque command for the facility 20B to perform manufacturing operation, and time-series data relate to a signal A and a signal B for the facility 20B. The manufacturing data 121 may include manufacture-related video data, manufacture-related audio data, data manually inputted by an operator, or the like.

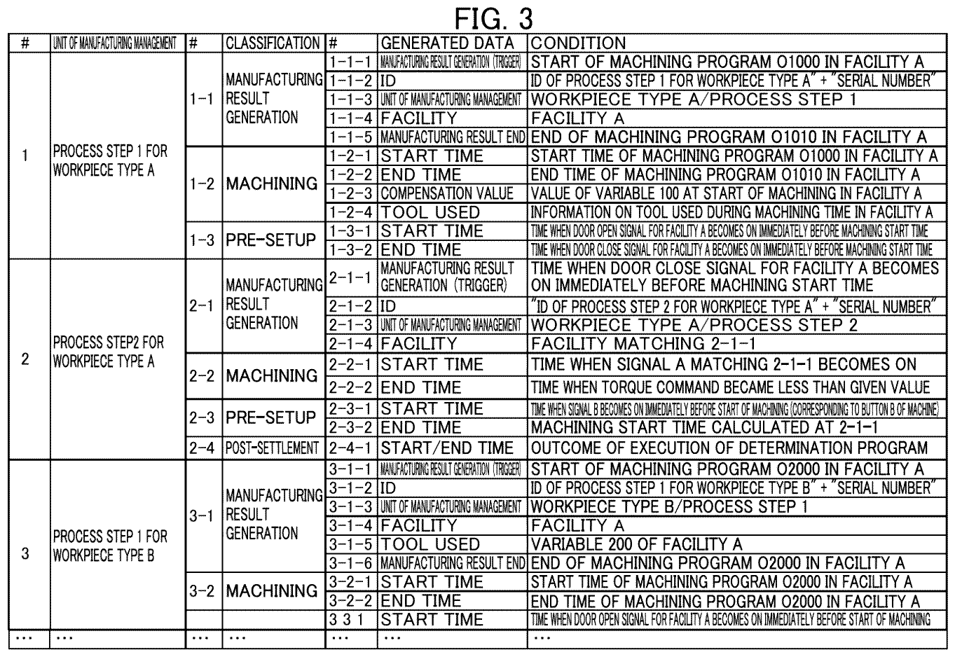

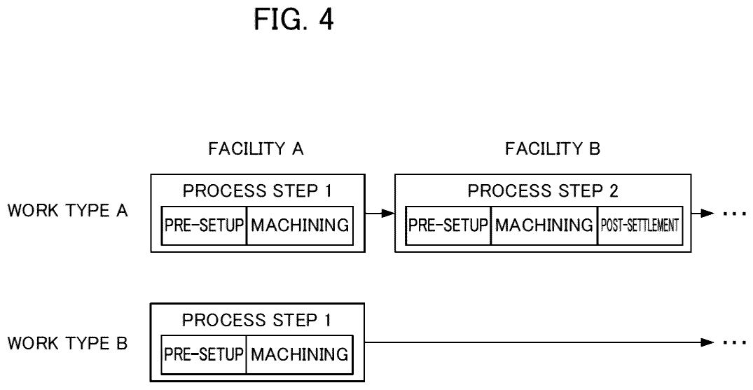

The manufacturing result generation conditions 122 include manufacturing result generation conditions set by the result. generation condition setting unit 112 (to be described later). FIG. 3 is a table illustrating an example of the manufacturing result generation conditions 122. As illustrated in FIG. 3, the manufacturing result generation conditions 122 include storage areas for “Unit of Manufacturing Management”, “Classification”, “Generated Data”, and “Condition”. Each of the storage areas denoted by “#” stores a number assigned to each “Unit Of Manufacturing Management”, a sub-number assigned to the “Classification” of each unit of manufacturing management based on the number, or a sub-number assigned to “Generated Data” and “Condition” for each classification. The storage areas for “Unit Of Manufacturing Management” in the manufacturing result generation conditions 122 each store a unit of manufacturing management, such as “Process Step 1 for Workpiece Type A”, “Process Step 2 for Workpiece Type A”, “Process Step 1 for Workpiece Type B”, and the like. FIG. 4 is a diagram illustrating an example of a relationship between the facilities 20A and 20B and the process steps on a per workpiece type basis. FIG. 4 indicates that the process step 1 for the workpiece type A and the process step 1 for the workpiece type B are performed in the facility A, and the process step 2 for the workpiece type A is performed in the facility B. The process step 1 for the workpiece type A and the process step 1 for the workpiece type B include a pre-setup task (workpiece attachment/detachment, tool preparation, etc.) that is performed by an operator. The process step 2 for the workpiece type A includes a pre-setup task and a post-settlement task that are performed by an operator. The storage areas for “classification” in the manufacturing result generation conditions 122 each store, for example, “manufacturing result generation”, “machining”, “pre-setup”, “post-settlement”, and the like for each storage area for “unit of manufacturing management”. As illustrated in FIG. 4, the post-settlement task may be omitted depending on the workpiece type or the facility. In the storage areas for “Classification” in the manufacturing result generation conditions 122, “post-settlement” is omitted from the process step 1 for the workpiece type A and the process step 1 for the workpiece type B. The storage areas for “generated data” in the manufacturing result generation conditions 122 each store “manufacturing result generation (trigger)”, “ID”, “unit of manufacturing management”, “facility”, “machining quantity”, “manufacturing result end”, “start time”, “end time”, “compensation value”, “tool used”, and the like in accordance with the storage areas for “unit of manufacturing management”. The storage areas for “condition” in the manufacturing result. generation conditions 122 store, for each storage area for “generated data”, the conditions for acquiring the generated data. The manufacturing result generation conditions illustrated in FIG. 3 may include conditions related to the presence or absence of the manufacturing instructions from the production management system (not shown). As will be described later, the result generation condition setting unit 112 can create a new manufacturing result generation condition and can edit or delete an existing manufacturing result generation condition, based on an instruction inputted by an operator via the input unit 13 (to be described later).

The manufacturing results 123 include manufacturing results that are manufacturing data generated for each arbitrary unit of manufacturing management by the manufacturing result generation unit. 113 (to be described later). This manufacturing data is generated from the manufacturing data 121 based on the manufacturing result generation conditions 122.

### Input Unit 13

The input unit 13 is, for example, a keyboard or a touch panel provided on the display unit 14 (to be described later), and receives input from an operator.

### Display Unit 14

The display unit 14 is, for example, a liquid crystal display or the like. As will be described later, the display unit 14 may display a user interface (VI) that allow for setting the manufacturing result generation conditions 122 by means of the result generation condition setting unit 112. The display unit 14 may display a UI that allows for ascertainment of the manufacturing results 123 generated by the manufacturing result generation unit 113 (to be described later).

### Control Unit 11

The control unit 11 includes a central processing unit (CPU), a read only memory (ROM), a RAM, a complementary metal-oxide-semiconductor (CMOS) memory, and the like, which are configured to communicate with each other via a bus, and are known to those skilled in the art. The CPU is a processor that controls the manufacturing information management device 10 as a whole. The CPU reads a system program and application programs stored in the ROM via the bus, and controls the entire manufacturing information management device 10 in accordance with the system program and the application programs. Due to this configuration, as illustrated in FIG. 1, the control unit 11 is configured to implement the functions of the manufacturing data acquisition unit. 111, the result generation condition setting unit 112, and the manufacturing result generation unit 113. The RAM stores various data such as temporary calculation data, display data, etc. The CMOS memory is backed up by a battery (not shown) and is configured as a non-volatile memory that maintains a storage state even when the manufacturing information management device 10 is turned off.

The manufacturing data acquisition unit 111 acquires, from each of the facilities 20A and 20B, manufacturing data including at least the manufacture-related time-series data illustrated in FIG. 2. The manufacturing data acquisition unit 111 stores the manufacturing data acquired from each of the facilities 20A and 20B in the manufacturing data 121 for each of the facilities 20A and 20B.

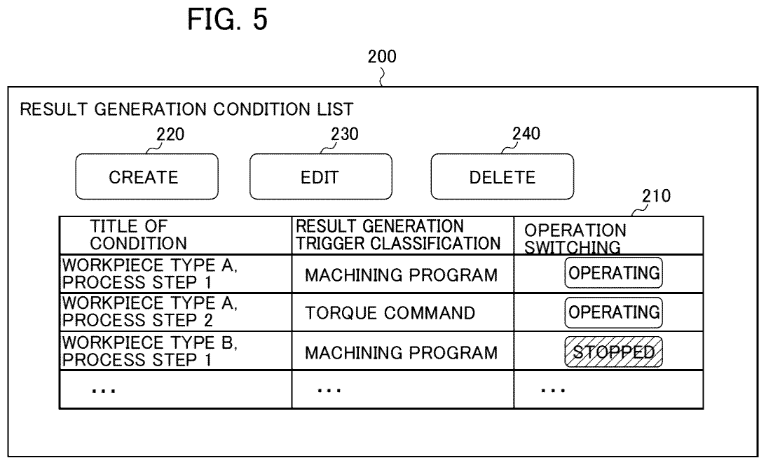

The result generation condition setting unit 112 sets the manufacturing result generation conditions illustrated in FIG. 3 based on, for example, an input operation by an operator via the input unit 13. Specifically, for example, upon receiving a setting instruction for setting a manufacturing result generation condition from the operator via the input unit 13, the result generation condition setting unit 112 displays, on the display unit 14, a result generation condition list screen that allows for setting the manufacturing result generation condition. FIG. 5 is a diagram illustrating an example of a result generation condition list screen 200. As illustrated in FIG. 5, the result generation condition list screen 200 is a user interface including a result generation condition list 210, a create button 220, an edit button 230, and a delete button 240. The result generation condition list 210 is a list of existing manufacturing result generation conditions and includes display areas for “Title of Condition”, “Result Generation Trigger Classification”, and “Operation Switching”. The display areas for “Title of Condition” in the result generation condition list 210 each display a workpiece type and a process step for each of the units of manufacturing management for which the manufacturing result generation conditions are set. The display areas for “Result Generation Trigger Classification” in the result generation condition list 210 each display the classification of a condition that triggers the manufacturing result generation (e.g., “machining program”, “torque command”, etc.). For example, referring to the manufacturing data 121 illustrated in FIG. 2, for “Workpiece Type A, Process Step 1” and “Workpiece Type B, Process Step 1”, a start of execution of the machining program “O1000” and a start of execution of the machining program “O2000” trigger the result generation. Accordingly, “Machining Program” is displayed in the respective display area for “Result Generation Trigger Classification” in the result generation condition list 210. For “Workpiece Type A, Process Step 2”, the result generation is determined based on a torque command, and accordingly, “Torque Command” is displayed in the display area for “Result Generation Trigger Classification” in the result generation condition list 210. The display areas for “Operation Switching” in the result generation condition list 210 each displays an “Operating” button or a “Stopped” button for switching the operation of generating a manufacturing result for the workpiece type and process step displayed in the display area for “Title of Condition”. For example, when the display area for “Operation Switching” displays the “Operating” button, it indicates that a manufacturing result for the corresponding workpiece type and process step is being generated. In response to an operator pressing the “Operating” button via the input unit 13, it switches to the “Stopped” button and the generation of manufacturing result for the corresponding workpiece type and process step stops. When the display area for “Operation Switching” displays the “Stopped” button, it indicates that generation of a manufacturing result for the corresponding workpiece type and process step is stopped. In response to the operator pressing the “stopped” button via the input unit 13, it switches to the “Operating” button and the manufacturing result for the corresponding workpiece type and process step is generated.

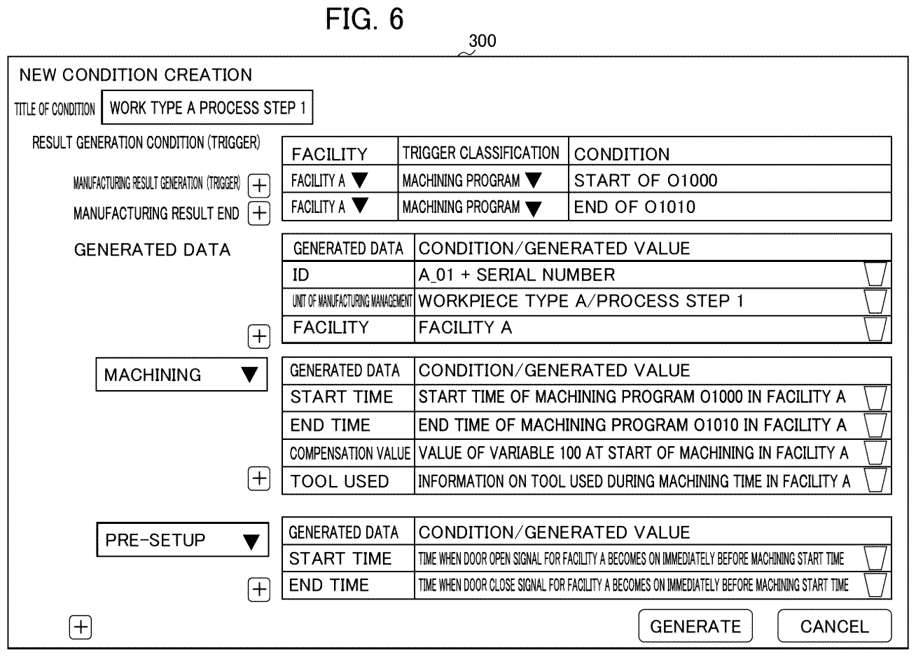

In response to the operator pressing the create button 220 via the input unit 13, the result generation condition setting unit 112 displays a new creation screen for creating a new manufacturing result generation condition on the display unit 14. FIG. 6 is a diagram illustrating an example of a new creation screen 300. FIG. 6 shows an example in which a manufacturing result generation condition for the unit of manufacturing management “Process Step 1 for Workpiece Type A” in FIG. 3 is newly created. As illustrated in FIG. 6, in the new creation screen 300, “Workpiece Type A, Process Step 1” is inputted in the field of “Title of Condition” in accordance with the operator's input operation. Here, the manufacturing result generation condition includes a result generation condition (trigger) for starting the generation of a manufacturing result itself and other conditions (e.g., “machining”, “pre-setup”, etc.). For the result generation condition (trigger), a manufacturing result generation (trigger) (i.e., manufacturing result generation start), manufacturing result end, and generated data are set. For the manufacturing result generation (trigger) and manufacturing result end, “Facility”, “Trigger Classification”, and “Condition” are set. For the generated data, “ID” as identification information that is assigned to the manufacturing result to be generated and identifies the manufacturing result, “Unit of Manufacturing Management” and “Facility” indicated by the manufacturing result, and the like are set. The operator may add an item to the conditions for manufacturing result generation (trigger), manufacturing result end, and generated data by pressing a plus (+) button. The operator may delete an item from the condition for the generated data by pressing a trash button. Although the “ID” of the generated data is a combination of a fixed value (e.g., “A_01”) and a serial number in the illustrated example, it may be only a serial number or a combination of a fixed value and date/time.

For other conditions, conditions/generation values for each classification, such as “machining” and “pre-setup” are set. The classification titles of the conditions/generation values may be prepared in advance and selected by the operator, or may be freely inputted by the operator. Alternatively, the conditions/generation values may describe what condition and what value are set for each item of the generated data in accordance with an input by the operator. Data used for setting the conditions/generation values and the like may be selected and specified by the operator from a list of the manufacturing data 121. In response to the operator pressing the “Create” button on the new creation screen 300 via the input unit 13, the result generation condition setting unit 112 stores the manufacturing result generation condition set on the new creation screen 300 in the manufacturing result generation conditions 122.

In response to the operator selecting one row from the result generation condition list 210 and pressing the edit button 230 via the input unit 13, the result generation condition setting unit. 112 displays an edit screen for editing the selected manufacturing result generation condition on the display unit 14. The edit screen is similar to the new creation screen 300 in FIG. 6, and detailed description of the edit screen is omitted herein. In response to the operator selecting one or more manufacturing result generation conditions from the result generation condition list 210 and pressing the delete button 240 via the input unit 13, the result generation condition setting unit 112 deletes the selected manufacturing result generation conditions from the manufacturing result generation conditions 122.

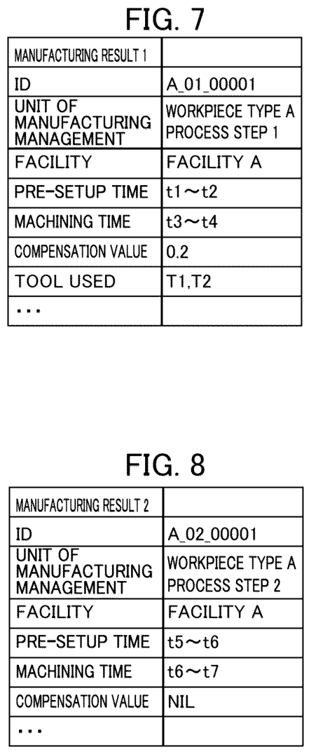

The manufacturing result generation unit 113 generates manufacturing data for each arbitrary unit of manufacturing management as a manufacturing result, from the manufacturing data 121 based on the manufacturing result generation conditions 122 set in advance, for example. Specifically, the manufacturing result generation unit 113 ascertains, for example, that in the manufacturing data 121 in FIG. 2, the machining program “O1000” started in the facility A at time t3. Then, the manufacturing result generation unit 113 ascertain that a door open signal is “ON” at time t1 and a door close signal is “ON” at time t2 immediately before time t3, based on the manufacturing result generation condition for the unit of manufacturing management “Process Step 1 for Workpiece Type 1” included in the manufacturing result generation conditions 122 in FIG. 3. The manufacturing result generation unit 113 ascertains that the machining program “O1010” ends at time t4, based on the manufacturing result generation condition for the unit of manufacturing management “Process Step 1 for Workpiece Type 1” in FIG. 3. In this way, the manufacturing result generation unit 113 generates “Manufacturing Result 1” illustrated in FIG. 7, in which “ID” is “A_01_00001”, “Unit of Manufacturing Management” is “Workpiece Type A” and “Process Step 1”, “Facility” is “Facility A”, “Pre-Setup Time” is “t1 to t2”, “Machining Time” is “t3 to t4”, “Compensation Value” is “0.2” that is a value of a variable 100 at the machining start point t3, and “Used Tools” are “T1, T2”, and so on. The manufacturing result generation unit 113 stores the generate manufacturing result in the manufacturing results 123.

Further, the manufacturing result generation unit 113 ascertains that, in the manufacturing data 121 in FIG. 2, the signal A for the facility B became “ON” at time t6, and from this point in time, the torque command was equal to or greater than a given value for a given period of time or longer. Then, the manufacturing result generation unit 113 ascertains that the signal B becomes “ON” at time t5 immediately before time t6, based on the manufacturing result generation condition for the unit of manufacturing management “Process Step 2 for Workpiece Type 1” included in the manufacturing result generation conditions 122 in FIG. 3. The manufacturing result generation unit 113 further ascertains that the torque command becomes less than the given value at time t7, based on the manufacturing result generation condition for the unit of manufacturing management “Process Step 2 of Workpiece Type 1” in FIG. 3. In this way, the manufacturing result generation unit 113 generates “Manufacturing Result 2” illustrated in FIG. 8, in which “ID” is “A_02_00001”, “Unit Of Manufacturing Management” is “Workpiece Type A” and “Process Step 2”, “Facility” is “Facility B”, “Pre-Setup Time” is “t5 to t6”, “Machining Time” is “t6 to t7”, and “Post-Settlement Time” is “nil”, and so on. The manufacturing result generation unit 113 stores the generated manufacturing result in the manufacturing results 123. The manufacturing result generation unit 113 determines the post-settlement time by executing a determination program stored (registered) in advance in the storage unit 12. Then, the manufacturing result generation unit 113 sets “nil” in the “Post-Setup Time” of the manufacturing result in FIG. 8 because the manufacturing result generation unit 113 has determined the post-setup time as “nil (0)” based on the result of the determination.

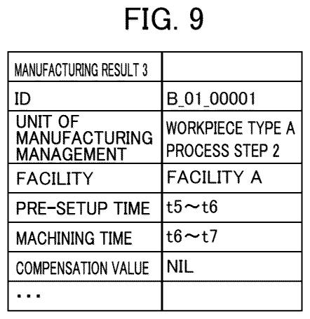

Further, the manufacturing result generation unit 113 ascertains that in the manufacturing data 121 in FIG. 2, the machining program “O2000” started at time t10 in the facility A. Then, the manufacturing result generation unit 113 ascertains that the door open signal is “ON” at time t8 and the door close signal is “ON” at time t9 immediately before time t10, based on the manufacturing result generation condition for the unit of manufacturing management “Process Step 1 for workpiece type B” included in the manufacturing result generation conditions 122 in FIG. 3. The manufacturing result generation unit 113 further ascertains that the machining program “O2000” ends at time t11, based on the manufacturing result generation condition for the unit of manufacturing management “Process Step 1 for workpiece type 2” in FIG. 3. In this way, the manufacturing result generation unit 113 generates “Manufacturing Result 3” illustrated in FIG. 9, in which “ID” is “B_01_00001”, “Unit of Manufacturing Management” is “Workpiece Type B” and “Process Step 1”, “Facility” is “Facility A”, “Pre-Setup Time” is “t8 to t9”, and “Machining Time” is “t10 to t11”. The manufacturing result generation unit 113 stores the generated manufacturing result in the manufacturing results 123.

Next, after generating the manufacturing results based on the manufacturing result generation conditions, the manufacturing result generation unit 113 calculates an index (score) that indicates a probability of each of the generated manufacturing results. In the following, a case (a) where the score (up to 100) indicating the probability of the manufacturing result generation is calculated from comparison with a standard lead time and a case (b) where the score is calculated from a degree of similarity of a torque command will be described as examples.

### (a) Case of Calculating the Score From Comparison With Standard Lead Time

The manufacturing result generation unit 113 sets in advance a standard lead time S and a standard deviation o thereof for each period of time (type of period of time) subjected to the score calculation, such as the “Machining Time” of “Process Step 1 for Workpiece Type A” in the manufacturing result illustrated in FIG. 7. The manufacturing result generation unit 113 may calculate the score in accordance with the following equation:
Score=100−(|S−t|/σ)×α, where t is the machining time of the generated manufacturing result (t=end time−start time), and & is an arbitrary constant. In a case where there are multiple periods of time to be subjected to the calculation, the manufacturing result generation unit 113 may calculate the average value of the scores of the multiple periods of time as the score.

### (b) Case of Calculating the Score From a Degree of Similarity of Torque Command

In this case, for example, it is assumed that a model pattern of a torque command pertaining to each type of period of time of the respective unit of manufacturing management is stored (registered) in advance in the storage unit 12. When generating a manufacturing result, the manufacturing result generation unit 113 acquires time-series data of a torque command for each type of period of time (e.g., the machining time, etc.) from the manufacturing data 121, based on the set manufacturing result generation conditions. The manufacturing result generation unit 113 calculates a degree of similarity between the acquired time-series data and the stored (registered) model pattern. The manufacturing result generation unit 113 may calculate the score by normalizing the calculated degree of similarity using known techniques (e.g., cross-correlation function (CCF), dynamic time warping (DTW), etc.).

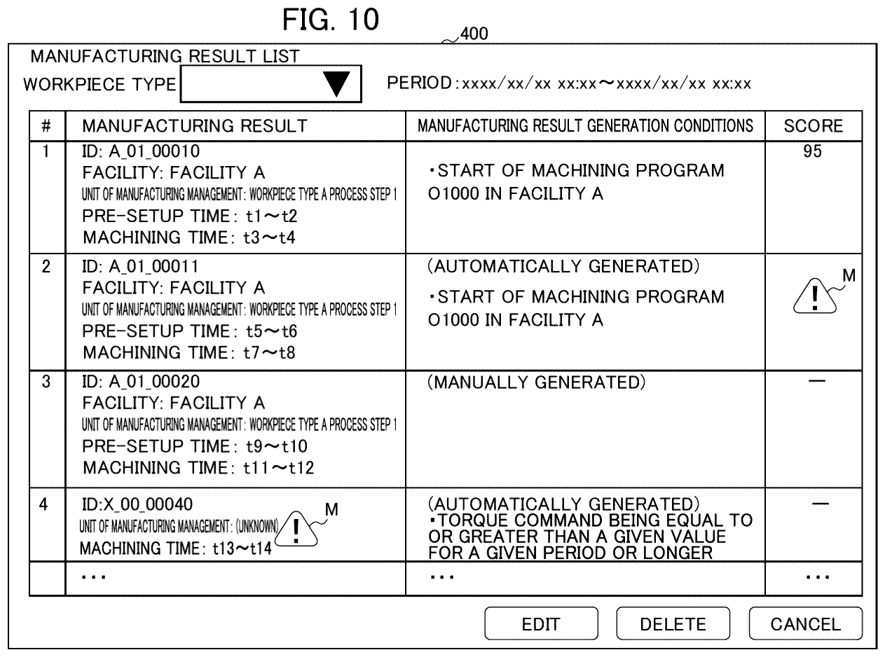

The manufacturing result generation unit 113 displays, on the display unit 14, a manufacturing result list screen that shows the list of generated manufacturing results, the manufacturing result generation conditions, and the calculated scores. FIG. 10 is a diagram illustrating an example of a manufacturing result list screen 400. As illustrated in FIG. 10, the manufacturing result list screen 400 is a user interface that has display areas for “Manufacturing Result”, “Manufacturing Result Generation Conditions”, and “Score”, and allows for filtering of the manufacturing results to be displayed by an arbitrary condition such as a period, a workpiece type, and a score. The display areas for “Manufacturing Result” in the manufacturing result list screen 400 each display information regarding the generated manufacturing result. The display areas for “Manufacturing Result Generation Conditions” in the manufacturing result list screen 400 each display the manufacturing result generation condition based on which the manufacturing result has been generated. The display area for “Manufacturing Result Generation Conditions” displays “Automatically Generated” together with a manufacturing result automatically generated based on a manufacturing result generation condition, and displays “Manually Generated” together with a manufacturing result manually inputted by an operator. The manufacturing result generation unit 113 may exclude the manually generated manufacturing result from the score calculation. In a case where the unit of manufacturing management is unknown at the time of generating a manufacturing result, the manufacturing result generation unit. 113 may indicate that the unit of manufacturing management is “Unknown” and display an attention attracting mark M, thereby prompting the operator to ascertain the unit of manufacturing management and the like. In this case, in response to the operator pressing the “Edit” button via the input unit 13, the manufacturing result generation unit 113 may correct the unit of manufacturing management and the like based on the outcome of the operator's ascertainment. The display areas for “Score” in the manufacturing result list screen 400 each display the score indicating the probability calculated by the manufacturing result generation unit 113. For a manufacturing result with a low score, such as 60 or less, the manufacturing result generation unit 113 may display, for example, an attention attracting mark M to prompt the operator to ascertain the correspondence between the manufacturing result and the manufacturing data 121 or the manufacturing result generation conditions 122, or the like. In this case, in response to the operator pressing the “Edit” button via the input unit 13, the manufacturing result generation unit 113 may correct the manufacturing result and the like based on the outcome of the operator's ascertainment.

### Generation Processing by Manufacturing Information Management Device 10

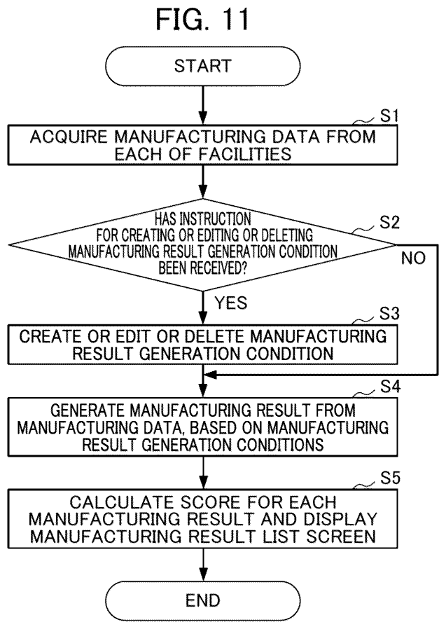

Next, a flow of generation processing by the manufacturing information management device 10 will be described with reference to FIG. 11. FIG. 11 is a flowchart illustrating the generation processing by the manufacturing information management device 10. The illustrated flow is repeatedly performed each time the manufacturing information management. device 10 receives manufacturing data from the facilities 20A and 20B.

In Step S1, the manufacturing data acquisition unit 111 acquires manufacturing data including at least the manufacture-related time-series data illustrated in FIG. 2 from each of the facilities 20A and 20B. The manufacturing data acquisition unit 111 stores the manufacturing data acquired from each of the facilities 20A and 20B in the manufacturing data 121 for each of the facilities 20A and 20B.

In Step S2, the result generation condition setting unit 112 determines whether or not an instruction for creating a new manufacturing result generation condition or an instruction for editing or deleting an existing manufacturing result generation condition has been received from an operator via the input unit 13. When the instruction for the creation or the instruction for the editing or deletion has been received, the processing proceeds to step S3. On the other hand, when the instruction for the creation or the instruction for the editing or deletion has not been received, the processing proceeds to Step S4.

In Step S3, the result generation condition setting unit. 112 creates the new manufacturing result generation condition, or edits or deletes the existing manufacturing result generation condition based on the input operation by an operator via the input unit 13.

In Step S4, the manufacturing result generation unit 113 generates manufacturing data for each unit of manufacturing management from the manufacturing data 121 as manufacturing results, based on the manufacturing result generation conditions 122.

In Step S5, the manufacturing result generation unit 113 calculates a score for each manufacturing result generated in Step S4 and displays the manufacturing result list screen 400 on the display unit 14. The manufacturing result generation unit 113 corrects the manufacturing results and the like based on an input operation by the operator via the input unit 13.

In the above-described manner, the manufacturing information management device 10 according to one embodiment can generate manufacturing results on a per unit of manufacturing management basis based on the preset conditions, from manufacturing data that is time-series data acquired from the facilities 20A and 20B. As the facilities 20A and 20B, existing facilities can be used as they are without improvement, such as additional input of signals or the like. Further, the manufacturing information management device 10 automatically collects the manufacturing data 121 without requiring an operator's time and effort, and can accurately generate the manufacturing results. Further, the manufacturing information management device 10 can generate the manufacturing result in real time.

### Modification

In the embodiment described above, the manufacturing data acquisition unit 111 acquires all the manufacturing data transmitted from the facilities 20A and 20B, but this is a non-limiting example. For example, the manufacturing information management device 10 may function as a manufacturing data acquisition condition setting unit that sets conditions for the manufacturing data to be acquired based on instructions inputted by an operator via the input unit 13. The manufacturing data acquisition unit 111 may acquire the manufacturing data transmitted from the facilities 20A and 20B based on the set manufacturing data acquisition conditions.

It should be noted that the functions included in the manufacturing information management device 10 in the embodiment can be implemented by hardware, software, or a combination thereof. Here, the implementation by software means that a computer reads and executes a program for the implementation.

The program can be stored in various types of non-transitory computer readable media and can be provided to a computer. The non-transitory computer readable media include various types of tangible storage media. Examples of the non-transitory computer readable media include a magnetic recording medium (e.g., a flexible disk, a magnetic tape, and a hard disk drive), a magnetic-optical recording medium (e.g., a magnetic optical disk), a read only memory (CD-ROM), a CD-R, a CD-R/W, and a semiconductor memory (e.g., a mask ROM, a programmable ROM (PROM), an erasable PROM (EPROM), a flash ROM, and a RAM). Furthermore, the program may be provided to the computer by way of various types of transitory computer readable media. Examples of the transitory computer readable media include an electrical signal, an optical signal, and an electromagnetic wave. Transitory computer readable medium can provide a program to the computer through a wired communication path, such as a wire and an optical fiber, or through a wireless communication path.

Steps of describing the program to be recorded on a recording medium include not only processes that are executed in time sequence in the order, but also processes that are executed in parallel or individually and not necessarily in time sequence. Furthermore, the steps of describing a program may be performed by cloud computing.

Although the present disclosure has been described in detail, the present disclosure is not limited to the individual embodiments described above. Various additions, replacements, modifications, partial deletions, and the like can be made to the above-described embodiments without deviating from the spirit of the present disclosure or without deviating from the spirit of the present disclosure derived from the contents of the claims and equivalents thereof. The above-described embodiments may also be implemented in combination. For example, in the above-described embodiments, the order of the operations and the order of the processing have been described as non-limiting examples. The same applies to a case where numerical values or mathematical formulas are used in the description of the embodiments described above.

The following further discloses additional remarks regarding the foregoing embodiments and variations thereof.

### (Additional Remark 1)

A manufacturing information management device (10) includes: a manufacturing data acquisition unit (111) that acquires manufacturing data including at least manufacture-related time-series data from facilities (20A, 20B); and a manufacturing result generation unit (113) that generates, from the manufacturing data, manufacturing data on a per arbitrary unit of manufacturing management basis as manufacturing results, based on preset manufacturing result. generation conditions.

### (Additional Remark 2)

In the manufacturing information management device (10) of Additional Remark 1, the manufacturing results generated by the manufacturing result generation unit (113) are information composed of a set of data items related to results of manufacture on a per unit of manufacturing management basis, and include at least identification information for identifying the manufacturing results.

### (Additional Remark 3)

The manufacturing information management device (10) of Additional Remark 1 further includes a manufacturing result generation condition setting unit (112) that sets the manufacturing result generation conditions.

### (Additional Remark 4)

The manufacturing information management device (10) of Additional Remark 1 further includes a manufacturing data acquisition condition setting unit that sets conditions for the manufacturing data acquisition unit to acquire the manufacturing data.

### (Additional Remark 5)

The manufacturing information management device (10) of Additional Remark 1 includes a display unit (14) that displays the manufacturing results generated by the manufacturing result generation unit 113 and information indicating a probability of manufacturing result generation for each of the manufacturing results.

### (Additional Remark 6)

A manufacturing information management method is for causing a computer to function as a manufacturing information management device (10), and includes: a manufacturing data acquisition step of acquiring manufacturing data including at least manufacture-related time-series data from facilities (20A, 20B); and a manufacturing result generation step of generating, from the manufacturing data, manufacturing data on a per arbitrary unit of manufacturing management basis as manufacturing results, based on preset manufacturing result. generation conditions.

### EXPLANATION OF REFERENCE NUMERALS

10: Manufacturing information management device
11: Control unit
111: Manufacturing data acquisition unit
112: Result generation condition setting unit
113: Manufacturing result generation unit
12: Storage unit
121: Manufacturing data
122: Manufacturing result generation conditions
123: Manufacturing results
13: Input unit
14: Display unit
20A, 20B: Facility
100: Manufacturing information management system

1. A manufacturing information management device comprising:
a manufacturing data acquisition unit that acquires manufacturing data including at least manufacture-related time-series data from a facility; and
a manufacturing result generation unit that generates, from the manufacturing data, manufacturing data on a per arbitrary unit of manufacturing management basis as manufacturing results, based on preset manufacturing result generation conditions.

2. The manufacturing information management device according to claim 1, wherein the manufacturing results generated by the manufacturing result generation unit are information composed of a set of data items related to results of manufacture on the per unit of manufacturing management basis, and include at least identification information for identifying the manufacturing results.

3. The manufacturing information management device according to claim 1, further comprising:
a manufacturing result generation condition setting unit that sets the manufacturing result generation conditions.

4. The manufacturing information management device according to claim 1, further comprising:
a manufacturing data acquisition condition setting unit that sets conditions for the manufacturing data acquisition unit to acquire the manufacturing data.

5. The manufacturing information management device according to claim 1, further comprising:
a display unit that displays the manufacturing results generated by the manufacturing result generation unit and information indicating a probability of manufacturing result generation for each of the manufacturing results.

6. A manufacturing information management method for causing a computer to function as a manufacturing information management device, the manufacturing information management. method comprising:
a manufacturing data acquisition step of acquiring manufacturing data including at least manufacture-related time-series data from s facility; and
a manufacturing result generation step of generating, from the manufacturing data, manufacturing data on a per arbitrary unit of manufacturing management basis as manufacturing results, based on preset manufacturing result generation conditions.
